(19) United States
(12) Patent Application Publication
(10) Pub. No.: US 2008/0199366 A1
(43) Pub. Date: Aug. 21, 2008

(54) Holder for specimen cup

(76) Inventor: Edwin J. Masters, Sikeston, MO (US)

Correspondence Address: Andrew D. O'Brien, 701 Bellevue, P.O. Box 818, Cape Girardeau, MO, 63701, US

(21) Appl. No.: 12/012,429

(22) Filed: Jan. 31, 2008

Related U.S. Application Data
(60) Provisional application No. 60/898,903, filed on Feb. 1, 2007.

(51) Int. Cl. B01L 9/00

(52) U.S. Cl. 422/104

(57) ABSTRACT

The present invention comprises a holder for a specimen cup, the holder comprising a curved member with a handle and a lever extending continuously therefrom. The curved member receives, engages, and grips the specimen cup. The handle provides a means to hold and carry the specimen cup without soiling one's hands. In addition, the handle and lever spread to expand the curved member's arc, thereby releasing the holder's grip on the specimen cup.

### CROSS-REFERENCE TO RELATED APPLICATIONS

Applicant hereby claims the benefit of U.S. provisional patent application No. 60/898,903, said provisional patent application No. 60/898,903 being incorporated herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A CD

Not Applicable

### BACKGROUND OF THE INVENTION

1. Field of the Invention

The present invention relates to devices for holding specimen cups used in the medical field to collect bodily fluid, such as urine, from patients. More specifically, the present invention relates to devices for holding a specimen cup during a specimen collection process.

2. Description of the Related Art

Bodily fluid samples are utilized for a variety of analytical and diagnostic purposes, including, but not limited to, testing for drugs, pregnancy, and infection. A common bodily fluid collection means entails the use of a cup into which an individual deposits his or her urine specimen. If an individual must hold the specimen cup directly, several complications may arise. For example, if the specimen strikes the individual before depositing into the cup, the sample may be contaminated and the individual's hand may be soiled. In addition, if the outside of the specimen cup is soiled, subsequent cup handlers may be exposed to unsanitary conditions. Furthermore, if holding the specimen cup directly, an individual may have to reach down into a toilet, which may also be unsanitary.

Several devices have been proposed to address these problems. For example, U.S. Pat. No. 5,558,840 proposes a holding ring with a hingedly attached handle.

In addition, U.S. Pat No. 5,147,342 proposes a rigid holder and detachable handle system in which the handle can also function as a lid for the specimen cup.

In addition, U.S. Pat. No. 6,013,230 proposes a holding ring and handle, where the handle is designed to collect errant specimen.

Furthermore, U.S. Pat. No. 6,719,951 proposes an assembly for specimen collection with a modified specimen cup and attachable handle.

However, all of these proposed devices have drawbacks. For example, where the devices are made of plastic, the device and plastic cup will often adhere to each other, especially where moisture exists between the cup and device. Although the device and cup may not forcefully adhere to each other, one must still manually separate the two pieces, which can cause the specimen cup to tip and spill its contents. In addition, disengagement may require the holder to use two hands.

Another drawback in the present field is the difficulty of manufacturing a device that is practical and economically feasible. For example, considering the nature of this field, any device to be used with a specimen cup must be capable of sterilization, sterile packing and sterile shipping. In addition, the device must be economical to manufacture, and where devices are manufactured by injection mold, more complex designs are not as cost-effective in the injection mold process.

Still another drawback is based on the near universality of presently used specimen collection cups and the inability of one to enter the market with a new cup design. As a result, specimen cup holders need to be adaptable to standard cup sizes.

Still another drawback stems from the difficulties of carrying and manipulating a holder which elevates one's hand above the holding means. Instead, a handle which extends more perpendicular from the specimen cup would be easier to manipulate where such a handle comprises a more natural extension of one's arm.

### SUMMARY OF THE INVENTION

Accordingly, there is now presented a holder for a specimen cup, the holder comprising a curved member with two extensions protruding therefrom. In one embodiment, the first protruding extension comprises a handle. In another embodiment, the second protruding extension comprises a lever. In another embodiment the curved member receives, engages, and grips the specimen cup. In a further embodiment, the handle and lever are capable of being spread to expand the curved member's arc, thereby reducing the holder's grip on an engaged specimen cup.

This invention provides several advantages to address drawbacks of the prior devices. First, the present invention provides a novel mechanism to release the holder from a specimen cup where the holder and cup have adhered to each other. This mechanism minimizes the risk of spilling specimen when removing the cup from the holder. In addition, this mechanism can be operated with one hand. Another advantage pertains to the simple design of the present invention thereby reducing manufacturing costs. Another advantage pertains to the size of the present invention, which allows the invention to be sterilized and stored in the same package as the specimen cup. Another advantage relates to the present invention's straight handle, thereby reducing the awkwardness of transporting and transferring the specimen cup and contained sample. Another advantage relates to the symmetry of the present invention, thereby enabling use with either a right or left hand.

Further objects and advantages of this invention will become apparent from considering the subsequent drawings, detailed description, and claims.

### BRIEF DESCRIPTION OF THE DRAWINGS

FIG. 1 is a top view of a holder.

FIG. 2 is a perspective view of a holder.

FIG. 3 is a perspective view of a holder.

FIG. 4 is a perspective view of a holder engaging a cup.

### DETAILED DESCRIPTION OF THE INVENTION

Throughout this detailed description of the invention and its preferred embodiments, the invention will be generally referred to by numeral 5 and is also generally described as “holder” or “specimen cup holder.”

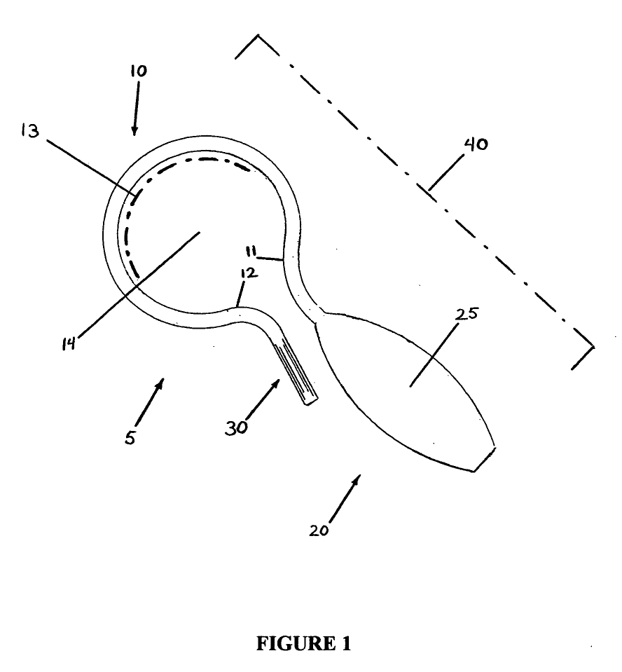

Referring to FIGS. 1-4, in one embodiment, the present invention 5 comprises a holder 5 for a specimen cup, said holder 5 comprising a curved member 10 with a handle 20 and a lever 30, both the handle 20 and lever 30 extending continuously from the curved member 10.

The term “lever” as used herein refers to any elongated member which extends continuously from the curved member 10, which can be used to spread the arc 13 of the curved member.

In one embodiment, the present invention 5 comprises a holder 5 for a specimen cup, said holder 5 comprising a curved member 10 with a first end 11 and a second end 12. In one embodiment the first end 11 comprises a handle 20 extending continuously from the first end 11. In another embodiment, the second end 12 comprises a lever 30 extending continuously from the second end 12.

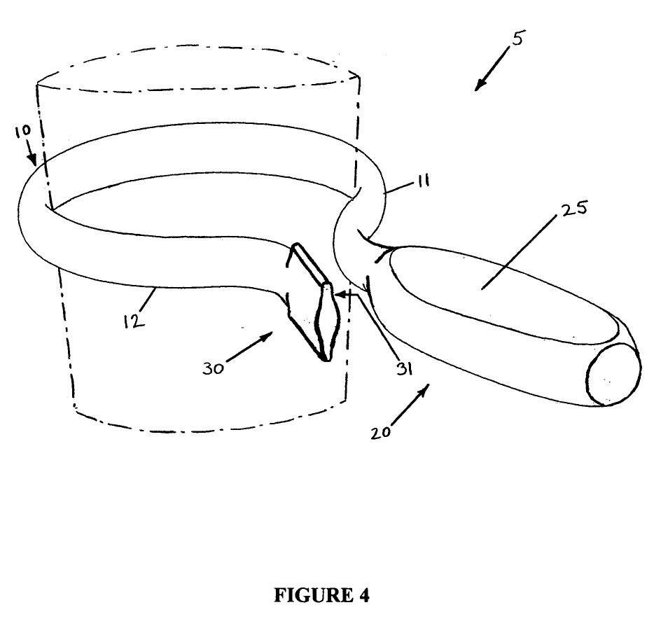

In a further embodiment, the curved member 10 is of sufficient size, length, and arc to create a center space 14 through which a specimen cup bottom can fit, said curved member 10 for receiving, engaging with, gripping, and securely supporting the specimen cup in an upright position. Cups of the type used to collect specimen samples are often tapered to enable the cups to stack. The specimen cup tapered design allows a specimen cup to fit through the center space 14, while also allowing the curved member 10 to engage the specimen cup. In another embodiment, as shown in FIG. 4, the curved member 10 engages with and grips the specimen cup. Essentially, when the curved member 10 engages a specimen cup, one can then carry and manipulate the specimen cup using the handle 20 attached to the curved member 10.

In a further embodiment, the handle 20 and lever 30 are spreadable and thereby capable of expanding the arc 13 of the curved member 10. In a further embodiment, expansion of the curved member arc 13 by spreading the handle 20 and lever 30 loosens the grip of the curved member on an engaged specimen cup, thereby permitting disengagement of a specimen cup from the holder 5. In a further embodiment, the handle 20 and lever 30 are proximately located thereby enabling one to grasp the handle 20 and one-handedly spread the lever 30 with the thumb of a grasping hand. In a further embodiment the lever 30 is shorter than the handle 20.

In a further embodiment, the combined length 40 of the curved member 10, handle 20, and lever 30 is such that the holder 5 fits with a specimen cup inside a sterile packaging.

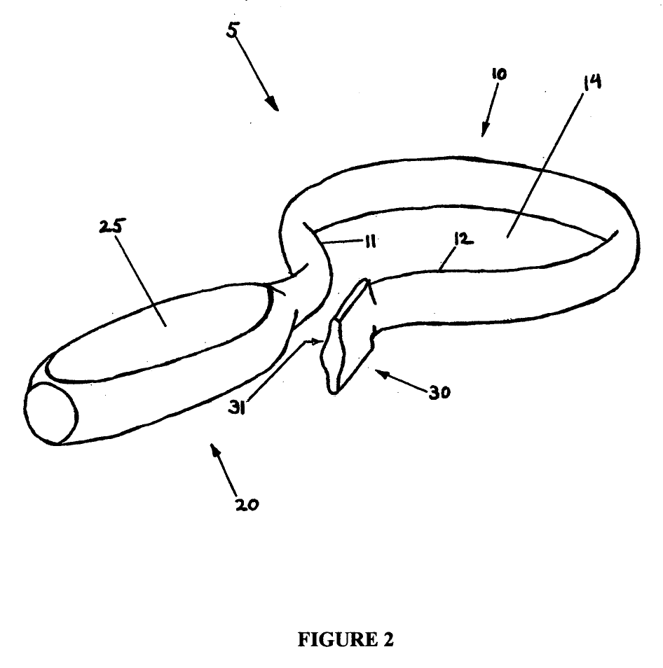

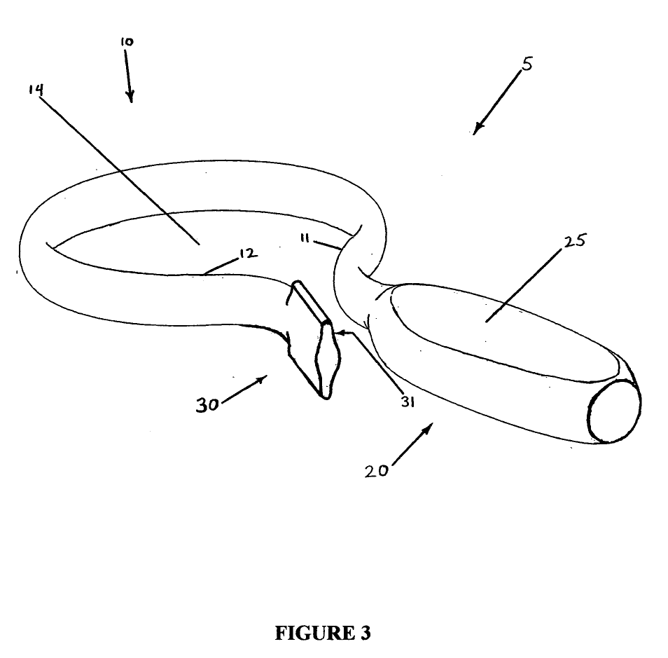

In a further embodiment, the holder 5 is symmetrical such that one can operate the holder with a left hand or a right hand. For example, as the holder 5 is illustrated in FIGS. 3 and 4, a user may grip the handle 20 with his or her right hand, thereby positioning his or her thumb in a proximate position to the lever 30. In order to release the grip of the holder 5 on an engaged cup, he or she can then increase the arc 13 of the curved member 10 by pushing against the interior side 31 of the lever 30. In the alternative, because the holder 5 is symmetrical, the holder 5 can be flipped, as shown in FIG. 2, such that one may operate the holder 5 with his or her left hand.

In a further embodiment, the handle provides a flat surface 25 of sufficient size such that information can be placed on the handle. For example, the flat surface 25 provides a site on which to print directions or drug information and advertisement.

The above detailed description is meant merely to provide illustrations of preferred embodiments of the invention and should not be construed as limiting the scope of the invention.

I claim:

1. A holder for a specimen cup, said holder comprising a curved member with a handle and a lever extending from said curved member.

2. The holder of claim 1 wherein said curved member comprises a first end and a second end,
the first end comprising a handle extending from the first end, and
the second end comprising a second member extending from the second end.

3. The holder of claim 2 wherein said curved member comprises a sufficient size, length, and arc to create a center space through which a specimen cup bottom can fit, said curved member for receiving, engaging with, gripping and securely supporting a held specimen cup in an upright position.

4. The holder of claim 2 wherein the handle and second member are spreadable, such that the arc of the curved member can be expanded, thereby loosening the grip of the curved member on a held specimen cup and allowing disengagement of the holder from the specimen cup.

5. The holder of claim 4 wherein the length of the handle and the length of the second member allow the holder to accompany a specimen cup inside sterile packaging.

6. The holder of claim 5 wherein the handle and the second member are proximately located, thereby enabling one to grasp the handle and one-handedly spread the second member with the thumb of a grasping hand.

7. The holder of claim 6 wherein said holder is symmetric such that one can operate the holder with a left hand or a right hand.

8. A holder for a specimen cup, said holder comprising a curved member of sufficient size, length, and arc to create a center space through which a specimen cup bottom can fit, said curved member for receiving, engaging with, and gripping a held specimen cup in an upright position, said curved member comprising a first end and a second end,
the first end comprising a handle extending from the first end, and
the second end comprising a second member extending from the second end,
wherein the handle and second member are spreadable, such that the arc of the curved member can be expanded, thereby loosening the grip of the curved member on a held specimen cup and allowing disengagement of the holder from the specimen cup,
wherein said first end and second end are proximately located, thereby enabling one to grasp the handle and one-handedly spread the second member with the thumb of a grasping hand; and
said holder is symmetric such that one can operate the holder with a left hand or a right hand.
